(19) United States
(12) Patent Application Publication
(10) Pub. No.: US 2023/0188300 A1
(43) Pub. Date: Jun. 15, 2023

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/164,192

(22) Filed: Feb. 3, 2023

Related U.S. Application Data
(63) Continuation of application No. PCT/JP2021/028862, filed on Aug. 3, 2021.
(60) Provisional application No. 63/061,300, filed on Aug. 5, 2020.

(51) Int. Cl. H04L 5/00; H04L 1/18

(52) U.S. Cl. CPC H04L 5/0055; H04L 1/18

(57) ABSTRACT

A communication control method includes by a Radio Link Control (RLC) entity of a communication apparatus being either of a user equipment or a relay node, transmitting a data packet to a parent node and then receiving a first acknowledgment corresponding to the data packet from the parent node, by the RLC entity, updating a transmission window managed at the RLC entity in response to the receiving the first acknowledgment, and by the communication apparatus, controlling, in response to receiving a second acknowledgment corresponding to the data packet from the parent node after the receiving the first acknowledgment, retransmission related to the data packet based on the second acknowledgment.

### RELATED APPLICATIONS

The present application is a continuation based on PCT Application No. PCT/JP2021/028862, filed on Aug. 3, 2021, which claims the benefit of U.S. Provisional Application No. 63/061300 filed on Aug. 5, 2020. The content of which is incorporated by reference herein in their entirety.

### TECHNICAL FIELD

The present disclosure relates to a communication control method used in a cellular communication system.

### BACKGROUND OF INVENTION

In the 3rd Generation Partnership Project (3GPP), which is a standardization project of a cellular communication system, a new relay node referred to as an Integrated Access and Backhaul (IAB) node is defined (for example, see “3GPP TS 38.300 V16.2.0 (2020-07)”). One or more relay nodes are involved in communication between a base station and a user equipment, and perform relay for the communication.

### SUMMARY

In a first aspect, a communication control method includes by a Radio Link Control (RLC) entity of a communication apparatus being either of a user equipment or a relay node, transmitting a data packet to a parent node and then receiving a first acknowledgment corresponding to the data packet from the parent node, by the RLC entity, updating a transmission window managed at the RLC entity in response to the receiving the first acknowledgment, and by the communication apparatus, controlling, in response to receiving a second acknowledgment corresponding to the data packet from the parent node after the receiving the first acknowledgment, retransmission related to the data packet based on the second acknowledgment.

In a second aspect, a communication control method includes by a Backhaul Adaptation Protocol (BAP) layer of a relay node, transmitting data packets to a parent node and storing the data packets in a retransmission buffer, by the BAP layer, receiving a status packet related to whether each of the data packets has been delivered to a donor base station from the donor base station via the parent node, and by the BAP layer, controlling retransmission of the data packets stored in the retransmission buffer based on the status packet.

In a third aspect, a communication control method includes configuring, by a donor base station for a relay node intervening between a child node and a parent node, an operation mode of a Radio Link Control (RLC) layer of the relay node. The configuring includes configuring, as the operation mode, a predetermined mode in which the relay node waits to transmit an acknowledgment to the child node until the relay node receives an acknowledgment from the parent node.

### BRIEF DESCRIPTION OF THE DRAWINGS

FIG. 1 is a diagram illustrating a configuration of a cellular communication system according to an embodiment.

FIG. 2 is a diagram illustrating a relationship between an IAB node, Parent nodes, and Child nodes according to an embodiment.

FIG. 3 is a diagram illustrating a configuration of a base station (gNB) according to an embodiment.

FIG. 4 is a diagram illustrating a configuration of a relay node (IAB node) according to an embodiment.

FIG. 5 is a diagram illustrating a configuration of a user equipment (UE) according to an embodiment.

FIG. 6 is a diagram illustrating a protocol stack related to an RRC connection and an NAS connection of an IAB-MT according to an embodiment.

FIG. 7 is a diagram illustrating a protocol stack related to an F1-U protocol according to an embodiment.

FIG. 8 is a diagram illustrating a protocol stack related to an F1-C protocol according to an embodiment.

FIG. 9 is a diagram illustrating an example of operation pattern 1 according to an embodiment.

FIG. 10 is a diagram illustrating an example of operation pattern 2 according to an embodiment.

FIG. 11 is a diagram for illustrating operation according to a variation.

FIG. 12 is a diagram illustrating a format of a BAP PDU (BAP Data PDU).

FIG. 13 is a diagram illustrating types of BH RLF notifications.

FIG. 14 is a diagram illustrating identified solutions for avoiding reestablishment to a descendant node.

FIG. 15 is a diagram illustrating a comparison of mechanisms for lossless delivery of UL data in a case of hop-by-hop RLC ARQ.

FIG. 16 is a diagram illustrating options of introduction of UL status delivery.

### DESCRIPTION OF EMBODIMENTS

In an embodiment, a cellular communication system will be described with reference to the drawings. In the description of the drawings, the same or similar parts are denoted by the same or similar reference signs.

### Configuration of Cellular Communication System

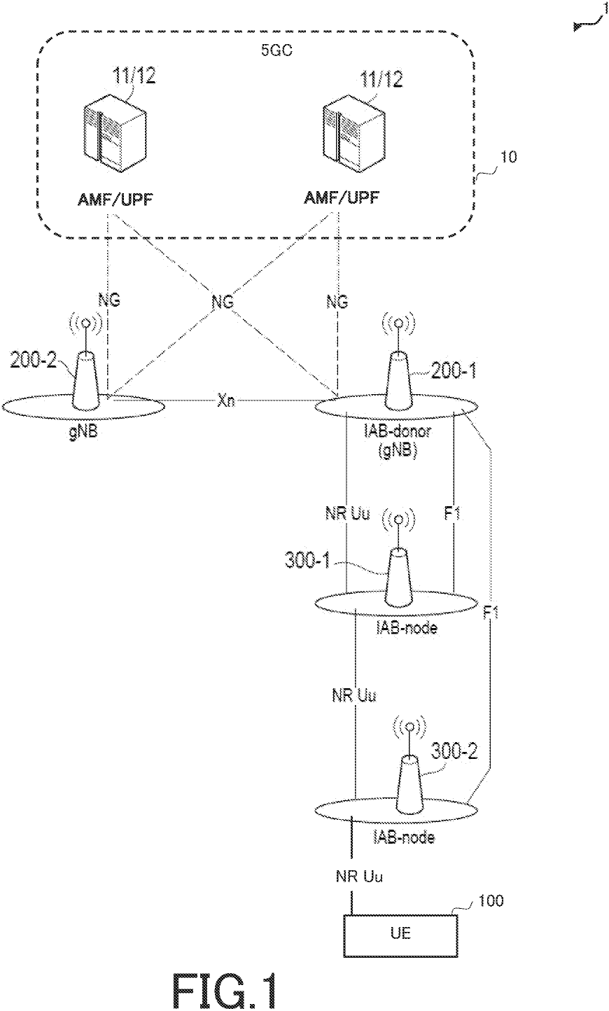

First, a configuration of the cellular communication system according to an embodiment will be described. FIG. 1 is a diagram illustrating a configuration of a cellular communication system 1 according to an embodiment.

The cellular communication system 1 is a fifth generation (5G) cellular communication system based on the 3GPP standard. Specifically, a radio access scheme in the cellular communication system 1 is New Radio (NR) being a radio access scheme of the 5G. Note that Long Term Evolution (LTE) may be at least partially applied to the cellular communication system 1.

As illustrated in FIG. 1, the cellular communication system 1 includes a 5G core network (5GC) 10, a User Equipment (UE) 100, base stations (referred to as gNBs) 200, and IAB nodes 300. Each IAB node 300 is an example of a relay node.

An example in which each base station is an NR base station will be mainly described below. However, the base station may be an LTE base station (i.e., an eNB).

The 5GC 10 includes an Access and Mobility Management Function (AMF) 11 and a User Plane Function (UPF) 12. The AMF 11 is an apparatus that performs various types of mobility controls and the like for the UE 100. The AMF 11 communicates with the UE 100 by using Non-Access Stratum (NAS) signaling, and thereby manages information of an area in which the UE 100 exists. The UPF 12 is an apparatus that performs transfer control of user data and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. One cell belongs to one carrier frequency.

Each gNB 200 is interconnected to the 5GC 10 via an interface referred to as an NG interface. FIG. 1 illustrates two gNBs, namely a gNB 200-1 and a gNB 200-2 that are connected to the 5GC 10.

Each gNB 200 is interconnected to another neighboring gNB 200 via an inter-base station interface referred to as an Xn interface. FIG. 1 illustrates an example in which the gNB 200-1 is connected to the gNB 200-2.

Each gNB 200 may be divided into a Central Unit (CU) and a Distributed Unit (DU). The CU and the DU are interconnected via an interface referred to as an F1 interface. The F1 protocol is a communication protocol between the CU and the DU and includes an F1-C protocol corresponding to a protocol for a control plane and an F1-U protocol corresponding to a protocol for a user plane.

The cellular communication system 1 supports an IAB that uses NR for the backhaul to enable wireless relay of NR access. The donor gNB 200-1 is a donor base station corresponding to a terminal node of the NR backhaul on the network end and including additional functions that support the IAB. The backhaul can implement multi-hop via a plurality of hops (i.e., a plurality of IAB nodes 300).

FIG. 1 illustrates an example in which an IAB node 300-1 is wirelessly connected to the donor gNB 200-1, an IAB node 300-2 is wirelessly connected to the IAB node 300-1, and the F1 protocol is transmitted via two backhaul hops.

The UE 100 is a mobile wireless communication apparatus that performs wireless communication with cells. The UE 100 may be any type of apparatus as long as the UE 100 is an apparatus that performs wireless communication with the gNB 200 or the IAB node 300. For example, the UE 100 is a mobile phone terminal, a tablet terminal, a laptop PC, a sensor, an apparatus that is provided in the sensor, a vehicle, or an apparatus that is provided in the vehicle. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor gNB 200-1 via the IAB node 300-2 and the IAB node 300-1.

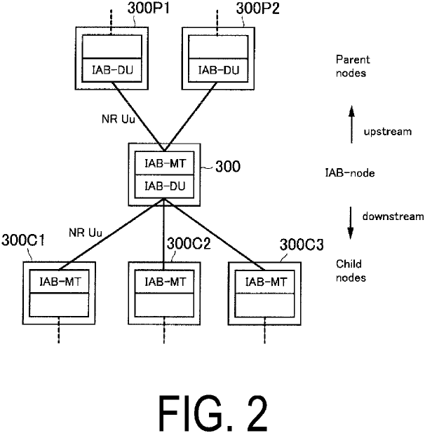

FIG. 2 is a diagram illustrating the relationship between the IAB node 300, the Parent nodes, and the Child nodes.

As illustrated in FIG. 2, each IAB node 300 includes an IAB-DU corresponding to a base station function unit and an IAB-Mobile Termination (MT) corresponding to a user equipment function unit.

Neighboring nodes on an NR Uu wireless interface of the IAB-MT (i.e., upper nodes) may be referred to as “parent nodes”. The parent node is the DU of a parent IAB node or a donor gNB 200. A radio link between the IAB-MT and each parent node is referred to as a backhaul link (BH link). FIG. 2 illustrates an example in which the parent nodes of the IAB node 300 are IAB nodes 300P1 and 300P2. Note that the direction toward the parent nodes is referred to as upstream. Seen from the UE 100, upper nodes of the UE 100 can correspond to the parent nodes.

Neighboring nodes on an NR access interface of the IAB-DU (i.e., lower nodes) may be referred to as “child nodes”. The IAB-DU manages cells in a manner the same as, and/or similar to the gNB 200. The IAB-DU terminates the NR Uu wireless interface connected to the UE 100 and the lower IAB nodes. The IAB-DU supports the F1 protocol for the CU of the donor gNB 200-1. FIG. 2 illustrates an example in which the child nodes of the IAB node 300 are IAB nodes 300C1 to 300C3; however, the UE 100 may be included in the child nodes of the IAB node 300. Note that the direction toward the child nodes is referred to as downstream.

### Configuration of Base Station

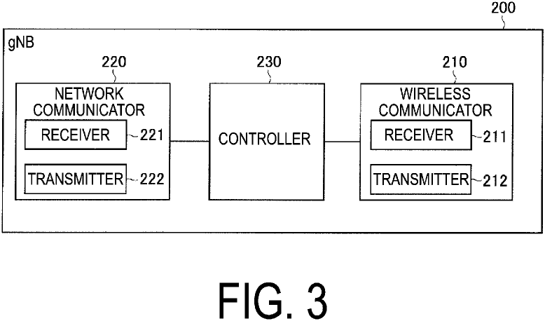

In an embodiment, a configuration of the gNB 200 that is a base station will be described. FIG. 3 is a diagram illustrating a configuration of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB node 300. The wireless communicator 210 includes a receiver 211 and a transmitter 212. The receiver 211 performs various types of reception under control of the controller 230. The receiver 211 includes an antenna, converts a radio signal received by the antenna into a baseband signal (received signal), and outputs the baseband signal to the controller 230. The transmitter 212 performs various types of transmission under control of the controller 230. The transmitter 212 includes an antenna, converts a baseband signal (transmission signal) to be output by the controller 230 into a radio signal, and transmits the radio signal from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from the outside and outputs the received signal to the controller 230. The transmitter 222 performs various types of transmission under control of the controller 230. The transmitter 222 transmits a transmission signal output by the controller 230 to the outside.

The controller 230 performs various types of controls in the gNB 200. The controller 230 includes at least one memory and at least one processor electrically connected to the memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The processor performs processing of the layers described below.

### Configuration of Relay Node

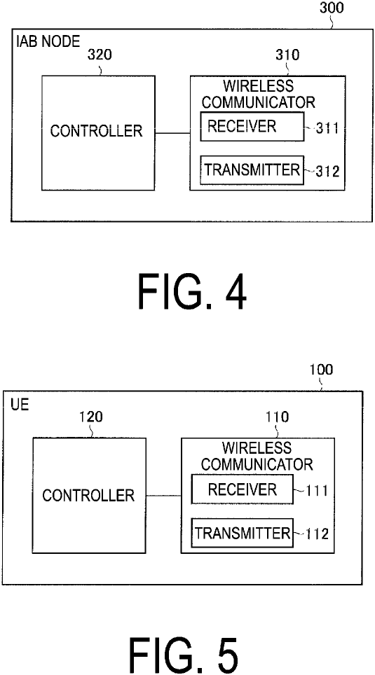

In an embodiment, a configuration of the IAB node 300 that is a relay node will be described. FIG. 4 is a diagram illustrating a configuration of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication (BH link) with the gNB 200 and performs wireless communication (access link) with the UE 100. The wireless communicator 310 for the BH link communication and the wireless communicator 310 for the access link communication may be provided separately.

The wireless communicator 310 includes a receiver 311 and a transmitter 312. The receiver 311 performs various types of reception under control of the controller 320. The receiver 311 includes an antenna, converts a radio signal received by the antenna into a baseband signal (received signal), and outputs the baseband signal to the controller 320. The transmitter 312 performs various types of transmission under control of the controller 320. The transmitter 312 includes an antenna, converts a baseband signal (transmission signal) to be output by the controller 320 into a radio signal, and transmits the radio signal from the antenna.

The controller 320 performs various types of controls in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below.

### Configuration of User Equipment

In an embodiment, a configuration of the UE 100 that is a user equipment will be described. FIG. 5 is a diagram illustrating a configuration of the UE 100. As illustrated in FIG. 5, the UE 100 includes a wireless communicator 110 and a controller 120.

The wireless communicator 110 performs wireless communication in the access link, specifically, wireless communication with the gNB 200 and wireless communication with the IAB node 300. The wireless communicator 110 may perform wireless communication in the sidelink, that is, wireless communication with another UE 100. The wireless communicator 110 includes a receiver 111 and a transmitter 112. The receiver 111 performs various types of reception under control of the controller 120. The receiver 111 includes an antenna, converts a radio signal received by the antenna into a baseband signal (received signal), and outputs the baseband signal to the controller 120. The transmitter 112 performs various types of transmission under control of the controller 120. The transmitter 112 includes an antenna, converts a baseband signal (transmission signal) to be output by the controller 120 into a radio signal, and transmits the radio signal from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below.

### Configuration of Protocol Stack

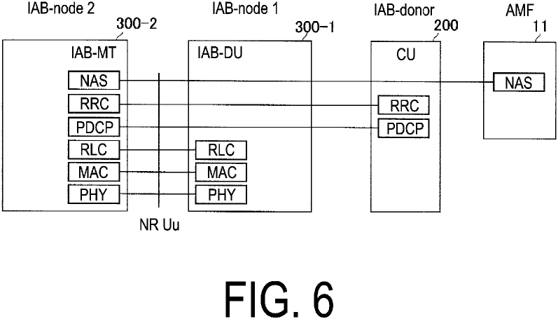

In an embodiment, a configuration of a protocol stack will be described. FIG. 6 is a diagram illustrating a protocol stack related to an RRC connection and an NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing by hybrid ARQ (HARQ), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines transport formats (transport block sizes, modulation and coding schemes (MCSs)) and resource blocks to be allocated, in the uplink and the downlink.

The RLC layer transmits data to the RLC layer on the reception end by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the donor gNB 200 via a radio bearer.

The RRC layer controls a logical channel, a transport channel, and a physical channel depending on establishment, reestablishment, and release of a radio bearer. RRC signaling for various configurations is transmitted between the RRC layer of the IAB-MT of the IAB node 300-2 and the RRC layer of the donor gNB 200. With an RRC connection to the donor gNB 200, the IAB-MT is in an RRC connected state. With no RRC connection to the donor gNB 200, the IAB-MT is in an RRC idle state.

The NAS layer located upper than the RRC layer performs session management, mobility management, and the like. NAS signaling is transmitted between the NAS layer of the IAB-MT of the IAB node 300-2 and the AMF 11.

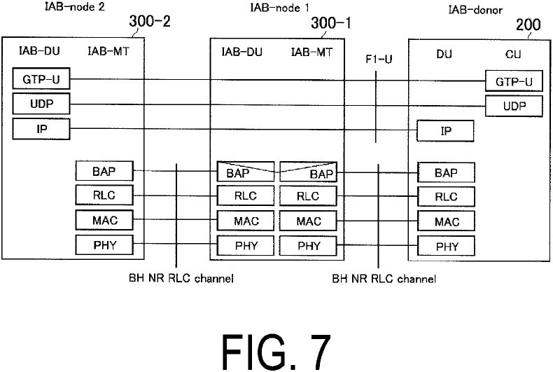

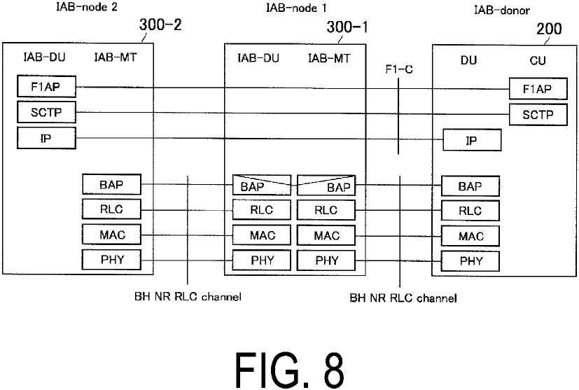

FIG. 7 is a diagram illustrating a protocol stack related to an F1-U protocol. FIG. 8 is a diagram illustrating a protocol stack related to an F1-C protocol. Here, an example in which the donor gNB 200 is divided into the CU and the DU is illustrated.

As illustrated in FIG. 7, each of the IAB-MT of the IAB node 300-2, the IAB-DU of the IAB node 300-1, the IAB-MT of the IAB node 300-1, and the DU of the donor gNB 200 includes a Backhaul Adaptation Protocol (BAP) layer as an upper layer of the RLC layer. The BAP layer is a layer that performs routing processing and bearer mapping and demapping processing. In the backhaul, the Internet Protocol (IP) layer is transmitted via the BAP layer to allow routing through a plurality of hops.

In each backhaul link, Protocol Data Units (PDUs) of the BAP layer are transmitted by the backhaul RLC channel (BH NR RLC channel). Configuring a plurality of backhaul RLC channels in each BH link enables the prioritization and Quality of Service (QoS) control of traffic. The association between the BAP PDU and the backhaul RLC channel is performed by the BAP layer of each IAB node 300 and the BAP layer of the donor gNB 200.

As illustrated in FIG. 8, the protocol stack of the F1-C protocol includes an Application Protocol (F1AP) layer and a Stream Control Transmission Protocol (SCTP) layer in place of a GPRS Tunnelling Protocol for User Plane (GTP-U) layer and a User Datagram Protocol (UDP) layer that are illustrated in FIG. 7, respectively.

### Operation of Cellular Communication System

Operations of the cellular communication system 1 according to an embodiment will be described.

In the cellular communication system 1, a failure can occur in the BH link. In particular, considering a mobile IAB node 300, a BH link failure continually occurs. When a BH link failure occurs, a mechanism of automatic retransmission control (Automatic Repeat reQuest (ARQ)) of the RLC layer can compensate packet loss in one radio section, but it is difficult to compensate packet loss with an end-to-end system in a case of multi-hop.

In order to implement end-to-end packet loss compensation by using the ARQ, transmitting an acknowledgment (Acknowledgment (ACK)) of the RLC layer by using a bucket brigade method is considered. Specifically, the relay node waits to transmit an RLC ACK to the child node until the relay node receives an RLC ACK from the parent node. With this, when packet loss occurs in a multi-hop path, transmission of the RLC ACK is also stopped, and thus packets can be retransmitted owing to a mechanism of data recovery in the PDCP layer. Specifically, in response to no delivery confirmation indication from the RLC layer, the PDCP layer performs retransmission of packets stored in a retransmission buffer of the PDCP layer. An operation mode of the RLC for delaying transmission of the RLC ACK as described above may be hereinafter referred to as a “bucket brigade RLC ARQ mode”.

The RLC layer manages a transmission window indicating a range of sequence numbers with which packets can be transmitted and updates the transmission window (that is, slides the transmission window) in response to reception of the RLC ACK. When the packets from the upper layer are out of the transmission window, the RLC layer discards the packets without transmitting the packets.

When the bucket brigade RLC ARQ mode is used, time from transmission of RLC packets until reception of the RLC ACK, that is, time to update the transmission window, is further increased as the number of hops increases or as a node becomes closer to the terminal end. In contrast, new packets from an upper layer reach the RLC layer one after another, and thus the new packets may fall out of the transmission window and may not be transmitted.

Note that, when a bit length of the sequence number is increased, accordingly a larger transmission window can be secured. This can solve the problem as described above but may increase an overhead of each packet.

An embodiment will describe a method that can solve the problem described above and can implement end-to-end packet loss compensation. Specifically, in a communication control method according to an embodiment, two types of ACKs, namely a first ACK for transmission window update and a second ACK for retransmission control are introduced. The transmission window is updated in an early stage by using the first ACK for transmission window update, and packet loss compensation is implemented by using the second ACK for retransmission control.

In other words, in the communication control method according to an embodiment, firstly, an RLC entity of a communication apparatus being either of the UE 100 or the IAB node 300 transmits a data packet to a parent node and then receives a first ACK corresponding to the data packet from the parent node. Secondly, the RLC entity updates a transmission window managed at the RLC entity in response to the reception of the first ACK. Thirdly, when the communication apparatus receives a second ACK corresponding to the data packet from the parent node after receiving the first ACK, the communication apparatus controls retransmission related to the data packet, based on the second ACK.

In operation pattern 1 to be described below, each of the first ACK and the second ACK is an ACK (that is, an RLC ACK) of an RLC layer. In operation pattern 2 to be described below, the first ACK is an RLC ACK, and the second ACK is an ACK defined in an upper layer than the RLC layer.

### Operation Pattern 1

Operation pattern 1 will be described. In operation pattern 1, a first ACK is referred to as a “first RLC ACK”, and a second ACK is referred to as a “second RLC ACK”.

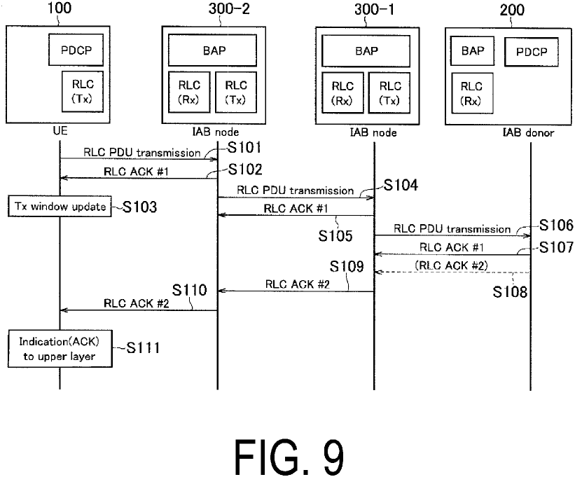

FIG. 9 is a diagram illustrating an example of operation pattern 1. In the illustration of FIG. 9, the RLC layer is separated into a receiving-end RLC entity (RLC (Rx)) and a transmitting-end RLC entity (RLC (Tx)).

As illustrated in FIG. 9, in Step S101, the transmitting-end RLC entity of the UE 100 transmits data packets (RLC PDUs) to the IAB node 300-2 and stores the data packets in the retransmission buffer. The receiving-end RLC entity of the IAB node 300-2 receives the data packets from the UE 100.

In Step S102, the receiving-end RLC entity of the IAB node 300-2 transmits the first RLC ACK (RLC ACK #1) to the UE 100 when receiving the data packets from the UE 100. The transmitting-end RLC entity of the UE 100 receives the first RLC ACK (RLC ACK #1) from the IAB node 300-2.

In Step S103, the transmitting-end RLC entity of the UE 100 slides the transmission window managed at the transmitting-end RLC entity of the UE 100 in response to receiving the first RLC ACK (RLC ACK #1) from the IAB node 300-2. Specifically, the transmitting-end RLC entity of the UE 100 sets (replaces) “TX_Next_RLC ACK” being a variable for defining a start point of the transmission window to (with) the smallest sequence number for which the RLC ACK has not been received.

At this time, the transmitting-end RLC entity of the UE 100 does not perform delivery confirmation indication to the PDCP layer being an upper layer. Note that, at this time, the transmitting-end RLC entity of the UE 100 may or may not discard data packets with confirmed delivery out of the data packets stored in the retransmission buffer.

In Step S104, the transmitting-end RLC entity of the IAB node 300-2 transmits the data packets (RLC PDUs) to the IAB node 300-1 and stores the data packets in the retransmission buffer. The receiving-end RLC entity of the IAB node 300-1 receives the data packets from the IAB node 300-2.

In Step S105, the receiving-end RLC entity of the IAB node 300-1 transmits the first RLC ACK (RLC ACK #1) to the IAB node 300-2 when receiving the data packets from the IAB node 300-2. The transmitting-end RLC entity of the IAB node 300-2 receives the first RLC ACK (RLC ACK #1) from the IAB node 300-1.

In Step S106, the transmitting-end RLC entity of the IAB node 300-1 transmits the data packets (RLC PDUs) to the donor gNB 200 and stores the data packets in the retransmission buffer. The receiving-end RLC entity of the donor gNB 200 receives the data packets from the IAB node 300-1.

In Step S107, the receiving-end RLC entity of the donor gNB 200 transmits the first RLC ACK (RLC ACK #1) to the IAB node 300-1 when receiving the data packets from the IAB node 300-1. The transmitting-end RLC entity of the IAB node 300-1 receives the first RLC ACK (RLC ACK #1) from the donor gNB 200.

In Step S108, the receiving-end RLC entity of the donor gNB 200 may transmit the second RLC ACK (RLC ACK #2) to the IAB node 300-1. Note that Step S108 is not necessarily required. The IAB node 300-1 has the donor gNB 200 as its parent node and may thus regard the first RLC ACK (RLC ACK #1) as the second RLC ACK (RLC ACK #2).

In Step S109, the receiving-end RLC entity of the IAB node 300-1 transmits the second RLC ACK (RLC ACK #2) to the IAB node 300-2 in response to receiving the second RLC ACK (RLC ACK #2) in Step S108 or in response to receiving the first RLC ACK (RLC ACK #1) in Step S107. The transmitting-end RLC entity of the IAB node 300-2 receives the second RLC ACK (RLC ACK #2) from the IAB node 300-1.

In Step S110, the receiving-end RLC entity of the IAB node 300-2 transmits the second RLC ACK (RLC ACK #2) to the UE 100 in response to receiving the second RLC ACK (RLC ACK #2) in Step S109. The transmitting-end RLC entity of the UE 100 receives the second RLC ACK (RLC ACK #2) from the IAB node 300-2.

In Step S111, the transmitting-end RLC entity of the UE 100 performs the delivery confirmation indication (Indication) to the PDCP layer being an upper layer in response to receiving the second RLC ACK (RLC ACK #2) in Step S110. At this time, the transmitting-end RLC entity of the UE 100 may discard the data packets corresponding to the ACK out of the data packets stored in the retransmission buffer. Note that the PDCP layer of the UE 100 has received the delivery confirmation indication from the transmitting-end RLC entity, and thus does not perform retransmission in the PDCP layer.

In contrast, when packet loss occurs between the UE 100 and the donor gNB 200, the transmitting-end RLC entity of the UE 100 does not receive the second RLC ACK (RLC ACK #2) nor perform delivery confirmation indication to the PDCP layer. In this case, the PDCP layer of the UE 100 triggers retransmission operation for restoring data and performs packet loss compensation. Note that, when the BAP layer is present in the UE 100, the BAP layer may perform the retransmission operation for restoring data, with the “PDCP layer” in the above description being replaced with the “BAP layer”.

In an embodiment, the first RLC ACK (RLC ACK #1) and the second RLC ACK (RLC ACK #2) may be the same RLC ACK information or may be different pieces of information. For example, the first RLC ACK (RLC ACK #1) may be a known RLC ACK (STATUS Control PDU), and the second RLC ACK may be another Control PDU such as UL status delivery (see operation pattern 2 to be described below).

In an embodiment, each of the first RLC ACK (RLC ACK #1) and the second RLC ACK (RLC ACK #2) may include an identifier to designate whether the RLC ACK is for the first time (for slide of the transmission window) or for the second time (for delivery confirmation indication to an upper layer). Alternatively, an identifier to designate whether the RLC ACK is for the first time (one hop data delivery confirmation, i.e., hop by hop delivery confirmation) or for the second time (delivery confirmation to the donor, i.e., end-to-end delivery confirmation) may be included.

The operation as described above (that is, operation of transmitting and receiving the RLC ACK twice for one RLC packet) may be performed only when a bearer (or a logical channel) that carries data is configured to a predetermined mode (for example, “Hybrid AM mode”). Here, the “Hybrid AM mode” is a mode different from existing Transparent Mode (TM), Unacknowledged Mode (UM), and Acknowledge Mode (AM).

The “Hybrid AM mode” may be a mode that can be configured only for the IAB node 300 (IAB-MT) or may be able to be configured for the UE 100. Such configuration may be performed from the CU of the donor gNB 200 to each IAB node 300 and the UE 100. For example, the configuration may be configured for each bearer (or for each logical channel), by using an RRC Reconfiguration message for the IAB-MT and the UE 100 and by using an F1-AP message for the IAB-DU.

An example in which the RLC entity of each IAB node 300 operates in AM has been described; however, a radio section where UM is applied may be present. For example, when an RLC mode between the UE 100 and the IAB node 300 is AM and an RLC mode between the IAB node 300 and the donor gNB 200 is UM, the IAB node 300 may immediately return the RLC ACK to the UE 100 without applying the bucket brigade method.

### Operation Pattern 2

Operation pattern 2 will be described mainly on its differences from operation pattern 1.

In operation pattern 2, retransmission control is performed in an upper layer than the RLC layer. An access IAB node being a parent node of the UE 100, not the UE 100, performs the retransmission control. Specifically, packet loss compensation is performed through retransmission control performed by the access IAB node, without changes being made to the UE 100.

In operation pattern 2, the RLC entity executes only update of the transmission window with a first acknowledgment (RLC ACK) (does not perform delivery confirmation indication to an upper layer), and the upper layer (BAP is mainly assumed) determines retransmission of the data packets through UL status delivery received in the upper layer. Here, UL status delivery is an example of a second acknowledgment and is composed of a BAP Control PDU, for example.

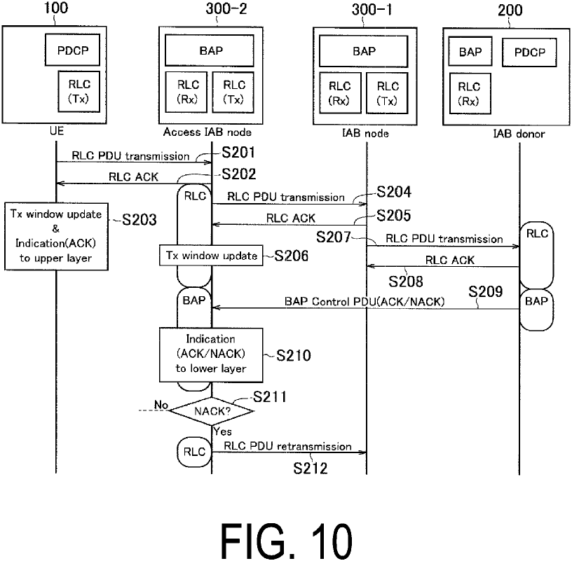

FIG. 10 is a diagram illustrating an example of operation pattern 2. In the illustration of FIG. 10, the RLC layer is separated into a receiving-end RLC entity (RLC (Rx)) and a transmitting-end RLC entity (RLC (Tx)).

As illustrated in FIG. 10, in Step S201, the transmitting-end RLC entity of the UE 100 transmits data packets (RLC PDUs) to the IAB node 300-2 and stores the data packets in the retransmission buffer. The receiving-end RLC entity of the IAB node 300-2 receives the data packets from the UE 100.

In Step S202, the receiving-end RLC entity of the IAB node 300-2 transmits the RLC ACK to the UE 100, when receiving the data packets from the UE 100. The transmitting-end RLC entity of the UE 100 receives the RLC ACK from the IAB node 300-2.

In Step S203, the transmitting-end RLC entity of the UE 100 slides the transmission window managed at the transmitting-end RLC entity of the UE 100, in response to receiving the RLC ACK from the IAB node 300-2. The transmitting-end RLC entity of the UE 100 performs delivery confirmation indication to the PDCP layer being an upper layer.

In Step S204, the transmitting-end RLC entity of the IAB node 300-2 transmits the data packets (RLC PDUs) to the IAB node 300-1 and stores the data packets in the retransmission buffer. The receiving-end RLC entity of the IAB node 300-1 receives the data packets from the IAB node 300-2.

In Step S205, the receiving-end RLC entity of the IAB node 300-1 transmits the RLC ACK to the IAB node 300-2 when receiving the data packets from the IAB node 300-2. The RLC ACK may be the delivery confirmation for the first time (RLC ACK #1) described above. The transmitting-end RLC entity of the IAB node 300-2 receives the RLC ACK from the IAB node 300-1.

In Step S206, the transmitting-end RLC entity of the IAB node 300-2 performs update of the transmission window in response to receiving the RLC ACK from the IAB node 300-1. Here, the transmitting-end RLC entity of the IAB node 300-2 does not perform delivery confirmation to an upper layer. Note that, even if the BAP layer receives the delivery confirmation indication from the transmitting-end RLC entity, the BAP layer ignores the delivery confirmation indication.

In Step S207, the transmitting-end RLC entity of the IAB node 300-1 transmits the data packets (RLC PDUs) to the donor gNB 200 and stores the data packets in the retransmission buffer. The receiving-end RLC entity of the donor gNB 200 receives the data packets from the IAB node 300-1.

In Step S208, the receiving-end RLC entity of the donor gNB 200 transmits the RLC ACK to the IAB node 300-1 when receiving the data packets from the IAB node 300-1. The transmitting-end RLC entity of the IAB node 300-1 receives the RLC ACK from the donor gNB 200.

In Step S209, the BAP layer of the donor gNB 200 transmits the BAP Control PDU (UL status delivery) corresponding to the second acknowledgment to the IAB node 300-2 via the IAB node 300-1 located in the middle. Here, the BAP Control PDU (UL status delivery) includes destination information (a BAP address of the IAB node 300-2) and a path ID as an option and is relayed in the BAP layer of the IAB node 300-1. The BAP layer of the IAB node 300-2 receives the BAP Control PDU (UL status delivery).

In Step S210, the BAP layer of the IAB node 300-2 indicates a delivery confirmation (or a non-delivery indication) based on the BAP Control PDU (UL status delivery) to a lower layer (transmitting-end RLC entity) of the IAB node 300-2. The transmitting-end RLC entity of the IAB node 300-2 receives the indication of the delivery confirmation (or the non-delivery indication) from an upper layer (BAP layer) of the IAB node 300-2.

In Step S211, the transmitting-end RLC entity of the IAB node 300-2 determines whether the indication from the BAP layer is the delivery confirmation (ACK) or the non-delivery indication (NACK). If the indication from the BAP layer is the delivery confirmation (ACK), the transmitting-end RLC entity of the IAB node 300-2 may delete (discard) corresponding data packets from the retransmission buffer of the IAB node 300-2.

In contrast, if the indication from the BAP layer is the non-delivery indication (NACK), in Step S212, the transmitting-end RLC entity of the IAB node 300-2 retransmits the data packets stored in the retransmission buffer to the IAB node 300-1.

Note that operation pattern 2 may be applied only in the “Hybrid AM mode” with a method the same as or similar to that of operation pattern 1.

FIG. 10 illustrates an example in which the second acknowledgment is transmitted and received between the IAB node 300-2 being the access IAB node and the donor gNB 200; however, for example, the second acknowledgment may be transmitted and received between the UE 100 and the donor gNB 200 (or the IAB node 300-1).

### Variations

Variations of the embodiment described above will be described. The variations of the embodiment are examples in which retransmission control is performed in the BAP layer as in operation pattern 2 described above.

In the variations, firstly, a BAP layer of the IAB node 300 transmits data packets to a parent node and stores the data packets in a retransmission buffer. Secondly, the BAP layer receives, from the donor gNB 200 via the parent node, a status packet (for example, UL status delivery described above) related to whether each of the data packets has reached the donor gNB 200. Thirdly, the BAP layer controls retransmission of the data packets stored in the retransmission buffer, based on the status packet.

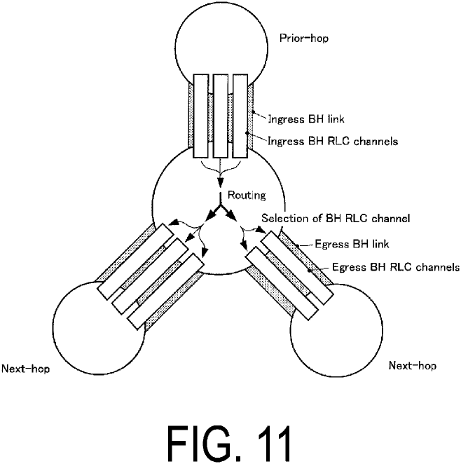

FIG. 11 is a diagram for illustrating operation according to a variation. FIG. 11 illustrates an example of one child node (that is, Prior-hop) of the IAB node 300 and two parent nodes (that are, Next-hops) of the IAB node 300 are present, and the BAP layer selects a BH RLC channel to perform routing.

As illustrated in FIG. 11, first, in accordance with routing configuration, the BAP layer delivers packets received from an ingress link (ingress BH link) to a lower layer (RLC layer) as BAP Data PDUs. In this case, the BAP layer stores the BAP Data PDUs in the retransmission buffer managed at the BAP layer. The BAP layer may receive a delivery confirmation from the lower layer (RLC layer). The delivery confirmation may be a delivery confirmation of the parent node (one hop). The BAP layer may store the fact that the BAP layer has successfully confirmed delivery of one hop in response to the delivery confirmation.

Next, the BAP layer receives, from the donor gNB 200 via the parent node, the status packet (UL status delivery) indicating whether each of the packets has been delivered to the donor gNB 200. The UL status delivery is transmitted by the BAP Control PDU. If the packets have reached the donor gNB 200 (in other words, if the delivery confirmation has been received), the BAP layer may discard the corresponding packets from the retransmission buffer.

In contrast, if the packets have not reached the donor gNB 200 (or if a retransmission request has been received), the BAP layer retransmits all of the packets stored in the retransmission buffer. Alternatively, the BAP layer may retransmit a part of the packets stored in the retransmission buffer. Here, “a part” refers to N packets from the oldest or from the newest or the like, for example. A value of N may be configured from the parent node (or the donor gNB 200). As will be described below, packets stored in or discarded from the retransmission buffer may be managed with a timer.

### Variation 1

Variation 1 is an example in which the BAP layer controls retransmission of the BAP PDUs by using a timer.

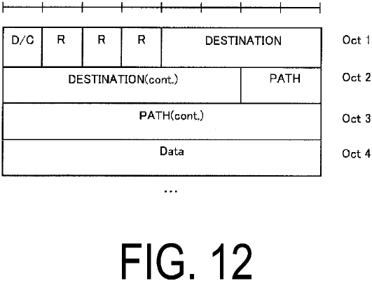

FIG. 12 is a diagram illustrating a format of the BAP PDU (BAP Data PDU). As illustrated in FIG. 12, the BAP PDU includes a DESTINATION field consisting of destination information, a PATH field consisting of a path ID, and a DATA field consisting of data. However, the BAP PDU does not include the sequence number. Thus, delivery confirmation for each BAP PDU is difficult to be performed. Thus, in Variation 1, retransmission control is performed by using a timer, instead of the sequence number.

The BAP layer according to Variation 1 starts the timer when the BAP layer stores data packets (BAP data PDUs) in the retransmission buffer. Then, when the timer expires, the BAP layer discards or retransmits the data packets stored in the retransmission buffer.

A) Description will be first provided regarding operation assuming that the status packet (UL status delivery) indicates a retransmission request, that is, a NACK.

In transmitting the data packets, the BAP layer stores duplicates of the packets in the retransmission buffer and starts the timer. A timer value of the timer may be configured from the donor gNB 200 to the IAB node 300. For the configuration from the donor gNB 200 to the IAB node 300, an RRC Reconfiguration message may be used, or an F1-AP message may be used.

Here, the BAP layer may manage the timer for each packet. In other words, the timers and the packets are associated on a one-to-one basis.

Alternatively, the BAP layer may manage one timer for N packets (N ≥ 2). In this case, the timer and the packets are associated on a one-to-N basis. How many packets are bundled together, that is, the value of N, may be configured from the donor gNB 200. One timer may be collectively associated with each routing ID (a set of Destination and Path).

When the timer expires (in other words, when there is no retransmission request during a timer period), the BAP layer discards the packet (or the packets) from the retransmission buffer. When the BAP layer retransmits the packet (or the packets) stored in the retransmission buffer in response to the retransmission request, the BAP layer discards (stops) or restarts (reboots from zero) the (associated) timer.

B) Description will be provided regarding operation assuming that the status packet (UL status delivery) indicates an acknowledgment, that is, an ACK.

The difference from A) described above is operation related to expiry of the timer. Specifically, when the BAP layer confirms that each of the packets has reached the donor gNB 200 (when the UL status delivery has been received), the BAP layer discards the packets from the retransmission buffer and discards (stops) the timer. In contrast, when the timer expires, the BAP layer retransmits the packets stored in the retransmission buffer.

### Variation 2

Variation 2 is an example in which retransmission of the BAP PDU is controlled depending on details of the status packet (UL status delivery).

In Variation 2, the status packet (UL status delivery) is assumed to be an indication that the donor gNB 200 has received N packets (in order). For example, the BAP layer that has received the status packets (UL status delivery) indicating that the donor gNB 200 has received 100 packets discards, of the packets stored in the retransmission buffer of the BAP layer, 100 packets from the oldest (for example, from packets having the smallest sequence numbers).

Alternatively, the status packet (UL status delivery) is assumed to be an indication that the donor gNB 200 fails in receiving the N-th packet. For example, the BAP layer that has received the status packet (UL status delivery) indicating that the donor gNB 200 has failed in receiving the tenth packet retransmits, of the packets stored in the retransmission buffer of the BAP layer, the tenth packet from the oldest (and some packets preceding and succeeding the tenth packet). In this case, the remaining packets up to the ninth packet may be deleted from the retransmission buffer without being retransmitted.

### Variation 3

Variation 3 is an example in which retransmission of the BAP PDU is controlled by making a change to a format of the BAP PDU to add a packet identifier (that is, a sequence number) to the BAP PDU. With this, in the status packet (UL status delivery), the ACK/NACK can be identified for each BAP PDU owing to the sequence number, and efficient retransmission can be thus implemented.

In Variation 3, for example, of the data packets stored in the retransmission buffer, the BAP layer discards a data packet having transmitted a sequence number indicated by the status packet (UL status delivery) and retransmits a data packet not having the transmitted sequence number.

As illustrated in FIG. 12, the BAP PDU includes a 3-bit R field, a DESTINATION field consisting of destination information, a PATH field consisting of a path ID, and a DATA field consisting of data. The BAP PDU may further include a SOURCE field (Source BAP address).

For example, one predetermined bit of the 3-bit R field is used as an identifier of an extended format of the BAP PDU having the sequence number (extended format in a case of “1”). A sequence number field is provided before the DESTINATION field or after the PATH field (before the Data field).

Application of the extended format of the BAP PDU may be configured from the donor gNB 200 to the IAB node 300. For example, the donor gNB 200 configures “BAP Data PDU type”, by using an RRC Reconfiguration message or an F1-AP message. Alternatively, in the bearer (RLC channel) configured to “Hybrid AM mode” described above, the extended format may be (automatically) applied, and the existing format may be unavailable. In this case, application of the extended format can be identified depending on the bearer (RLC channel) in use, which can thus eliminate the identification of the extended format using the “R” bit.

The BAP layer may assign a series of sequence numbers to all of the Egress links (RLC channels) (see FIG. 11). This method is a simple method for performing delivery confirmation to the donor gNB 200, because all of the packets are addressed to one donor gNB 200 in the upstream. The method; however, may bring about massive values of the sequence numbers. Alternatively, the BAP layer assigns a series of sequence numbers separately to each Routing ID (a set of Destination and Path). This allows for a smooth retransmission request and the like for each Path and enables distribution of the values of the sequence numbers for each Path, but may cause processing to be complicated to a certain extent. These methods of assigning the sequence numbers may be configured from the donor gNB 200.

The sequence number may be assigned to the BAP PDU only in the BAP layer of the access IAB node described above (that is, only in the ingress packets from the access link of the UE 100). In this case, each IAB node 300 located between the access IAB node and the donor gNB 200 does not assign the sequence number to the BAP PDU.

### Other Embodiments

Application of the bucket brigade RLC ARQ mode according to an embodiment described above may be configured from the donor gNB 200. Specifically, the donor gNB 200 configures the operation mode of the RLC layer for the IAB node 300 intervening between the child node and the parent node. Here, the donor gNB 200 may configure a predetermined mode (that is, the bucket brigade RLC ARQ mode) in which the IAB node 300 waits to transmit the RLC ACK to the child node until the IAB node 300 receives the RLC ACK from the parent node. Regarding the RLC entity in AM, the IAB node 300 operates in the bucket brigade RLC ARQ mode, based on the configuration. Note that, in the IAB node 300, coordinated operation between the IAB-DU and the IAB-MT may be performed via the BAP layer. Thus, the BAP layer may recognize the RLC mode (for example, AM, or the bucket brigade RLC ARQ) of each RLC entity.

The configuration from the donor gNB 200 to a target IAB node 300 may be to configure the bucket brigade RLC ARQ mode. The configuration from the donor gNB 200 to the target IAB node 300 may be to indicate configuration of an RLC ARQ operation mode of the parent node of the target IAB node 300 or the donor gNB 200, that is, any one of a bucket brigade mode (bucket brigade RLC ARQ mode), a UL Status Delivery mode (operation pattern 2 described above), and a regular ARQ (AM) mode. The configuration from the donor gNB 200 to the target IAB node 300 may be to indicate that IAB topology to which the target IAB node 300 belongs supports the bucket brigade RLC ARQ operation mode or to indicate that IAB topology to which the target IAB node 300 belongs ensures upstream packet delivery to the donor gNB 200.

The configuration from the donor gNB 200 to the target IAB node 300 may be performed by using an F1-AP message or may be performed by using an RRC message. Alternatively, the configuration may be configured from Operations, Administration AND Maintenance (OAM) to the target IAB node 300.

The configuration from the donor gNB 200 to the target IAB node 300 may be applied to (collectively configured for) the whole IAB nodes including the IAB-DU and the IAB-MT or may be applied to (individually configured for) each bearer, logical channel, or RLC entity.

The embodiments and variations described above illustrate an example in which an upper layer of the RLC layer is the BAP layer but are not limited to this. Any upper layer of the RLC layer can perform the same and/or similar operation, and for example, an RRC layer, an adaptation layer for relay transmission, and the like may be used in place of the BAP layer. The embodiments and variations described above provide description by taking relay transmission performed by the IAB as an example, but are not limited to this, and may be applied to other relay transmission systems. For example, operations according to the embodiments and variations described above may be applied to a relay node (layer 3 relay node), sidelink relay (relay node using a sidelink used for communication between terminals), and the like.

In the embodiment described above, an example has been mainly described, in which the cellular communication system 1 is a 5G cellular communication system. However, the base station in the cellular communication system 1 may be an eNB that is an LTE base station. The core network in the cellular communication system 1 may be an Evolved Packet Core (EPC). The gNB can be connected to the EPC, the eNB can be connected to the 5GC, and the gNB and the eNB may be connected via an inter-base station interface (Xn interface or X2 interface).

A program may be provided that causes a computer to execute each of the processing operations according to the embodiments and the variations described above. The program may be recorded in a computer-readable medium. Use of the computer readable medium enables the program to be installed on a computer. Here, the computer readable medium on which the program is recorded may be a non-transitory recording medium. The non-transitory recording medium is not particularly limited and may be, for example, a recording medium such as a CD-ROM and a DVD-ROM. A chip set may be provided that includes a memory that stores a program for executing each of the processing operations performed by the UE 100, the gNB 200, or the IAB node 300 and a processor that executes the program stored in the memory.

### Supplementary Notes

### Introduction

A revised work item related to Enhancements to Integrated Access and Backhaul (NR eIAB) was approved. Some of the purposes thereof are as follows.

### Enhancements of Topology Adaptation

Specification of procedures for inter-donor IAB-node migration to enhance robustness and load-balancing, including enhancements to reduce signaling load.
Specification of enhancements to reduce service interruption due to IAB-node migration and BH RLF recovery.
Specification of enhancements to topology redundancy, including support for CP/UP separation.

### Enhancements of Topology, Routing, and Transport

Specification of enhancements to improve topology-wide fairness, multi-hop latency, and congestion mitigation.

In Supplementary Notes, a first matter to be considered regarding the topology adaptation enhancements of a Rel-17 eIAB will be discussed from the viewpoint of assumption of backhaul link quality, enhancements of BH RLF indication, BH RLF recovery and cell (re)selection, and enhancements of lossless delivery.

### Discussion

### Assumption of Backhaul Link Quality

In the stage of research of Rel-15, as one requirement background, TR states the following: “Radio backhaul links are vulnerable to obstructions caused by a moving object such as a vehicle, change of seasons (leaves), change of infrastructure (new buildings), and the like. Such vulnerability is true for physically motionless IAB nodes as well”. Thus, as has been captured in TR, various problems caused by multi-hop/radio backhaul and potential solutions for these problems were researched.

Finding 1: In the research of Rel-15, various problems caused by unstable backhaul links and potential solutions for these problems were identified, which were fully captured in TR 38.874.

In normative work of Rel-16, it was assumed that the IAB nodes are motionless, that is, “stationary IAB nodes”. Accordingly, the backhaul (BH) was sufficiently stable in appropriately designed deployment even in a case of a backhaul link via millimeter waves and/or a local area IAB node that may be deployed with an unmanaged method. Thus, only a recovery procedure combined with basic functions of the BH RLF was defined. The basic functions are existing functions such as BH RLF indication (also known as type 4 that is “Recovery failure”) and RRC reestablishment, MCG/SCG failure indication, and/or a conditioned handover.

Finding 2: In a Rel-16 IAB, only a stationary IAB node including a sufficiently stable backhaul link was assumed.

In enhancements of Rel-17, one intended use case is a “mobile IAB node”, which may be a part of “inter-donor IAB-node migration” even if not explicitly described in WID. Secondary purposes in WID such as “enhancements to reduce service interruption due to IAB-node migration and BH RLF recovery” and “enhancements to topology redundancy” clearly intend that the BH link is not stable, and the migration and the BH RLF frequently occur in a Rel-17 deployment scenario. Therefore, according to the discussion of Rel-17, first, RAN2 should have common understanding about assumption of the BH link.

Proposal 1: RAN2 should assume that quality of the backhaul link dynamically changes. Thus, a backhaul RLF is not rare as with the Rel-17 eIAB.

### Enhancements of BH RLF Indication

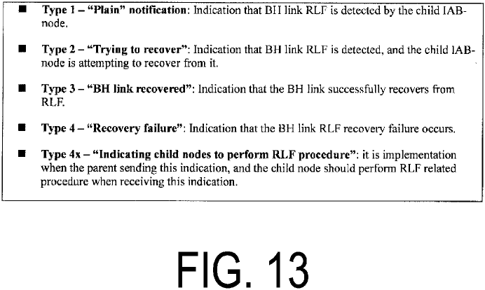

In email discussion of Rel-16, four types of BH RLF notifications as illustrated in FIG. 13 were discussed.

Ultimately, only “Recovery failure” being type 4 is defined as the BH RLF indication of Rel-16. With this, a child IAB-MT considers an RLF on the BH link and initiates an RLF recovery procedure.

Finding 3: In Rel-16, only “Recovery failure” being type 4 was defined as the BH RLF indication.

On the other hand, a number of companies were still considering that other types of indications were useful, and thus this was further discussed via email. Eight out of thirteen companies preferred introduction of “Trying to recover” being type 2, and other two companies thought this would be discussed in Rel-17. Accordingly, it can be assumed that a large number of companies consider that they are prepared to introduce the indication of type 2 to Rel-17. A method for transmitting the indication of type 2 requires further study. Examples of the method include using the BAP Control PDU, the SIB1, or both of these. Note that type 1 and type 2 have completely the same meaning.

Proposal 2: RAN2 should agree with the fact that “Trying to recover” being type 2 of the BH RLF indication has been introduced. Whether the transmission is performed using the BAP Control PDU, the SIB1, or both of these requires further study.

Nine out of thirteen companies agreed to hold a discussion on “BH link recovered” being type 3 in Rel-17 as well. Specifically, such an explicit indication is really needed can be studied. For example, when the indication of type 2 is transmitted via the SIB1 and the BH link is not under the RLF (i.e., “recovered”), the indication is no longer broadcast. Accordingly, downstream IAB nodes and the UE shall recognize whether the BH link has been recovered based on the absence of indication of type 2 on the SIB1. As a matter of course, when the indication of type 3 is transmitted via the BAP Control PDU, it has an advantage that the downstream IAB nodes can promptly know that the BH link has been recovered. Note that, in this case, the UE does not include the BAP layer and thus cannot know the fact. Therefore, RAN2 should discuss whether the indication of type 3 is necessary.

Proposal 3: If Proposal 3 can be agreed on, RAN2 should discuss whether to introduce an explicit BH RLF indication, that is “BH link recovered” being type 3, when the BH RLF is no longer present.

If Proposal 2 and/or Proposal 3 can be agreed on, operation during recovery of the BH link of the IAB-MT that has received the indication should be studied. The following was proposed: when the IAB-MT receives type 2, the IAB-MT reduces/stops the SR, and when the IAB-MT receives type 3 (i.e., the BH RLF is no longer present in a parent IAB node), the IAB-MT resumes operation. This is one desirable operation of the IAB-MT when the parent node is trying to recover the BH link. It is assumed that other operations of the IAB-MT, such as operation of suspending all of the RBs, are also possible.

Proposal 4: RAN2 should agree with that the IAB-MT, who has received the indication of type 2 and then reduced/stopped the scheduling request, resumes the scheduling request when the BH RLF is no longer present in the parent node.

Proposal 5: RAN2 should have a discussion about when an operation of other IAB-MT is present while the parent node is trying to recover the BH link.

While the BH link of the IAB node is under the RLF, it is assumed that the IAB-DU, which transmits an indication, transmits the BH RLF indication of type 2. When an RLF occurs in the BH link, an indication is transmitted, and thus a case of the BH of single connection is easy. However, a case of the BH with duplex connection is slightly more complicated. For example, when the IAB node detects an RLF in the MCG, the IAB node initiates an MCG failure information procedure; however, the SCG continues to function as a BH link, and therefore the indication of type 2 may not need to be transmitted at this time. When the MCG failure information procedure fails due to expiry of T316 or the like, the IAB-MT initiates RRC reestablishment, and therefore at this time, the indication of type 2 is transmitted. Thus, the indication of type 2 is transmitted when RRC reestablishment is initiated, not when the MCG/SCG failure information is triggered. In any case, because this concerns operation of the IAB-DU, whether to capture this in a specification/how to capture this should be carefully studied. That is, whether to add notes in stage 2 or stage 3 or nothing needs to be captured should be studied.

Proposal 6: RAN2 should agree on the fact that the BH RLF indication of type 2 may be transmitted when the IAB-DU initiates RRC reestablishment, not when the IAB-DU initiates any of the RLF recovery procedures.

Proposal 7: RAN2 should discuss whether to capture the operation of the IAB-DU (i.e., Proposal 6) in a specification/how to capture the operation.

### Enhancements of BH RLF Recovery and Cell (Re)Selection

In an RRC reestablishment procedure, the IAB-MT first executes a cell selection procedure in order to find an appropriate cell. In the cell selection procedure, potential problems were pointed out in Rel-16, such as one that the IAB-MT may select its descendant node. Thus, this was discussed in email discussion.

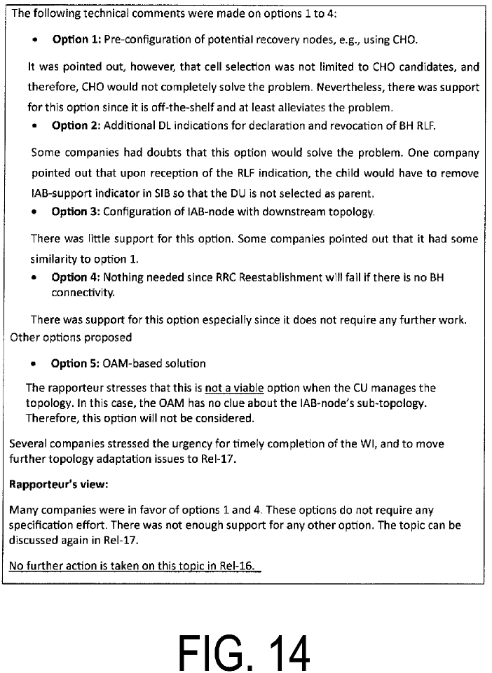

As illustrated in FIG. 14, possible five solutions were discussed and summarized together with the rapporteur’s view.

The conclusion was that “no further action is taken on this topic in Rel-16”. This means that RAN2 agreed on “Option 4: Nothing needed since RRC Reestablishment will fail if there is no BH connectivity”. Option 4 requires waiting for a failure (expiry of T301) and finally going to an idle state and was thus acceptable in a Rel-16 deployment scenario even when further time is required for BH RLF recovery.

Finding 4: In Rel-16, when the IAB node attempts an RRC reestablishment request to the descendant node, the IAB node needs to wait for a failure of the attempt, and finally go to an idle state.

In Rel-17, from the viewpoint of Proposal 1, cell (re)selection and RRC reestablishment may frequently occur. Thus, suboptimal operation, that is, operation in accordance with Finding 4, shall cause significant deterioration in performance from the viewpoint of stability of the IAB topology and service continuity. Thus, in order to optimize the operation of the IAB-MT during BH RLF recovery, “the topic can be discussed again in Rel-17”, as stated by the rapporteur of the above email discussion.

Proposal 8: RAN2 should agree on study on optimization of cell (re)selection in order to avoid reestablishment to an inappropriate node (for example, a descendant node).

It may be assumed that a common concept in the solutions identified except for Option 4 above is that the IAB-MT is provided with a type of either a whitelist or a blacklist for the purpose of cell selection. For example, given that topology changes may frequently occur in Rel-17 due to “inter-donor IAB-node migration”, the whitelist and the blacklist have advantages and disadvantages depending on the topology and the positions of the IAB nodes.

For example, from the viewpoint of an IAB node close to an IAB donor, that is, the uppermost in DAG topology, because the number of candidate nodes is small, and in some cases only an IAB donor DU, providing the whitelist is more reasonable.

However, in another example as a viewpoint of an IAB node very distant from an IAB donor, that is, the lowest in DAG topology, a great number of candidate nodes may need to be included in the whitelist. Instead, for example, a blacklist includes only downstream IAB nodes of the IAB node to be concerned and in some cases includes only a small number of child IAB nodes, and thus in this case, it has an advantage that overhead is small.

One matter of concern of the whitelist is that, due to the property of “inter-donor IAB-node migration” of Rel-17, candidate IAB nodes belonging to different/adjacent IAB topology may need to be included, which may result in increasing the size of the list. On the other hand, needless to say, downstream IAB nodes belong to the same IAB topology, and thus the blacklist need not consider the matter.

Finding 5: The whitelist and the blacklist have advantages and disadvantages depending on the topology and the positions of the IAB nodes.

Thus, when information is provided to the child IAB node for the purpose of cell selection, the IAB donor (or the parent IAB node) is desirable to be able to select either the whitelist or the blacklist. Note that the information may be useful if being reused for the purpose of cell reselection.

Proposal 9: RAN2 should agree on provision of the whitelist or the blacklist (i.e., selection structure) to the IAB-MT for the purpose of cell selection in order to avoid reestablishment to a descendant node. Whether these lists can also be used for a cell reselection procedure requires further study.

If Proposal 9 can be agreed on, a method of providing the information, that is, the whitelist or the blacklist, should be further studied. Option 1 assumes CHO configuration, and some enhancements may be required. Option 2 assumes additional indications, examples include the BH RLF indication of type 2. Option 3 assumes provision of information of the overall topology, which is not present in the existing configuration. Option 5 assumes OAM-based configuration; however, this is questionable as the rapporteur pointed out.

Considering again the assumption of Rel-17 (i.e., Proposal 1), that is, the fact that the parent IAB node or the IAB donor should provide a list to the child IAB node in case of occurrence of topology change, the method of providing the whitelist/blacklist should be a dynamic method. Thus, Option 5, that is, OAM, should be excluded. Which method, that is, which method out of Options 1, 2, and 3, is to be used as the baseline for the enhancements requires further study.

Proposal 10: RAN2 should agree on the fact that the parent IAB node or the IAB donor dynamically provides the whitelist/blacklist every time the topology is changed. The details thereof require further study.

### Enhancements of Lossless Delivery

In the stage of research of Rel-15, the problem of multi-hop RLC ARQ was discussed and captured in Section 8.2.3 of TR. In Rel-16, the protocol stack was defined for the IAB including unsplit RLC layers. In other words, in Rel-16, end-to-end ARQ was excluded, and hop-by-hop ARQ was adopted.

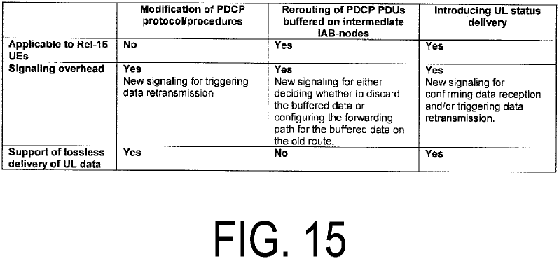

Regarding the hop-by-hop ARQ, the problem in end-to-end reliability, that is, lossless delivery with UL packets, was identified. As illustrated in FIG. 15, three solutions were identified and evaluated.

In Rel-16, “Modification of PDCP protocol/procedures” being a first solution was not adopted because it would affect a Rel-15 UE.

“Rerouting of PDCP PDUs buffered on intermediate IAB-nodes” being a second solution was supported as implementation selection in the BAP layer. The BAP layer may implement the second solution on the assumption that “data buffering in a transmission part of a BAP entity until an RLC-AM entity receives an acknowledgment response is implementation dependent, for example”. These BAP implementations were considered in order to avoid packet loss in “most” of the cases of the Rel-16 deployment scenario, that is, when the stationary IAB node was used; however, it was not perfect as in FIG. 15, for example.

“Introducing UL status delivery” being a third solution was a promised solution for guaranteeing lossless delivery of UL data, with evaluation results cited in FIG. 15 taken into consideration. The idea was to delay the RLC ARQ to the UE, so that PDCP data recovery at the UE is initiated when necessary. However, this was not defined in Rel-16 because it had been assumed that UL packets would be rarely dropped due to topology change as the stationary IAB node was assumed.

Considering the assumption of Rel-17, that is, from the viewpoint of Proposal 1, it is no longer rare that UL packets are lost during the topology change, which occurs frequently in Rel-17, and thus the third solution should be further studied. Thus, RAN2 should discuss an enhancement mechanism for guaranteeing lossless delivery in an L2 multi-hop network, in addition to the results captured in TR.

Proposal 11: RAN2 should agree on introduction of the solution identified in TR 38.874, that is, the mechanism to guarantee lossless delivery under a condition that the topology change may frequently occur based on “UL status delivery” of some form.

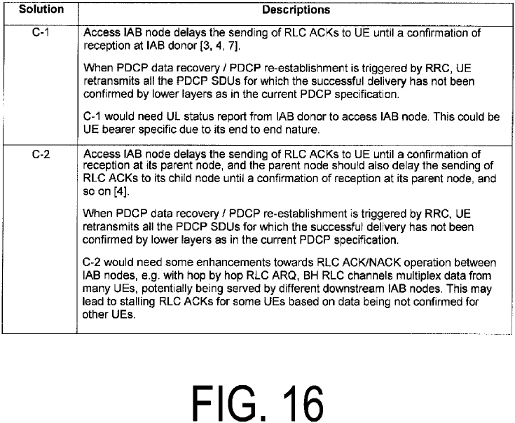

The details of the third solution, that is, “Introducing UL status delivery”, were discussed in two options, namely C-1 and C-2, in email discussion as illustrated in FIG. 16.

Regarding C-1 above, it is assumed that a “confirmation” from the IAB donor needs to be defined in the BAP or the RRC for end-to-end signaling forwarding via the multi-hop L2 network. Thus, in order to define the option, a relatively high standard effort shall be required.

Regarding C-2 above, when C-2 fully functions in the IAB topology and the RLC ACK is to be transmitted to the UE (or the downstream IAB node) even if it needs to be assumed that OAM configures all of the IAB nodes with the use of the option, it finally depends on IAB-DU implementation, and thus C-2 can be actually implemented for a Rel-16 IAB node as well. Because hop-by-hop feedback is assumed and no additional Control PDUs are assumed, C-2 is easier to implement than C-1. Thus, C-2 should be the baseline for the enhancements of Rel-17 for lossless delivery of the UL packets.

Finding 6: C-2 being a solution of “Introducing UL status delivery” may be the baseline for the enhancements of Rel-17, and this can be implemented for Rel-16 as well.

Note that, because Rel-17 should assume dynamic topology change that causes UL packet loss, the enhancements of Rel-17 shall support C-2 as a standard support function. At least in the specification of stage 2, an overall mechanism based on C-2 should be described. Otherwise, in the 3GPP standard, lossless delivery is not guaranteed during the handover of the IAB node. In stage 3, although minor changes such as those of the RLC and/or the BAP are assumed, these are regarded as internal operations of the IAB node, and thus details thereof may not be defined.

Proposal 12: RAN2 should agree on definition of an RLC ARQ mechanism for implementing lossless delivery of the UL packets in stage 2. This delays transmission of the ACK to the child node/UE before the ACK is received from the parent IAB node (i.e., C-2). Whether to define this in stage 3/how to define this require further study.

1. A communication control method comprising:
by a Radio Link Control (RLC) entity of a communication apparatus being either of a user equipment or a relay node, transmitting a data packet to a parent node and then receiving a first acknowledgment corresponding to the data packet from the parent node;
by the RLC entity, updating a transmission window managed at the RLC entity in response to the receiving the first acknowledgment; and
by the communication apparatus, controlling, in response to receiving a second acknowledgment corresponding to the data packet from the parent node after the receiving the first acknowledgment, retransmission related to the data packet based on the second acknowledgment.

2. The communication control method according to claim 1, wherein
each of the first acknowledgment and the second acknowledgment is an acknowledgment of an RLC layer, and
the controlling the retransmission comprises notifying, by the RLC entity, a PDCP layer of the communication apparatus of successful delivery of the data packet, based on the second acknowledgment.

3. The communication control method according to claim 1, wherein
the first acknowledgment is an acknowledgment defined in an RLC layer, and the second acknowledgment is an acknowledgment defined in an upper layer than the RLC layer, and
the controlling the retransmission comprises controlling, by the upper layer, the retransmission based on the second acknowledgment.

4. The communication control method according to claim 3, wherein
even when the upper layer receives, from the RLC layer, notification of successful delivery of the data packet, the upper layer ignores the notification.

5. A communication control method comprising:
by a Backhaul Adaptation Protocol (BAP) layer of a relay node, transmitting data packets to a parent node and storing the data packets in a retransmission buffer;
by the BAP layer, receiving a status packet related to whether each of the data packets has been delivered to a donor base station from the donor base station via the parent node; and
by the BAP layer, controlling retransmission of the data packets stored in the retransmission buffer based on the status packet.

6. The communication control method according to claim 5, further comprising:
starting a timer when the data packets are stored in the retransmission buffer; and
discarding or retransmitting the data packets stored in the retransmission buffer when the timer expires.

7. The communication control method according to claim 5, wherein
the controlling the retransmission comprises, among the data packets stored in the retransmission buffer, discarding a data packet having a delivered packet identifier indicated by the status packet and retransmitting a data packet not having the delivered packet identifier.

8. A communication control method comprising
configuring, by a donor base station for a relay node intervening between a child node and a parent node, an operation mode of a Radio Link Control (RLC) layer of the relay node, wherein
the configuring comprises configuring, as the operation mode, a predetermined mode where the relay node waits to transmit an acknowledgment to the child node until the relay node receives an acknowledgment from the parent node.
